(19) United States
(12) Patent Application Publication
(10) Pub. No.: US 2022/0276121 A1
(43) Pub. Date: Sep. 1, 2022

(54) EXCITATION DEVICE

(71) Applicant: Honda Motor Co., Ltd., Tokyo (JP)

(72) Inventors: Susumu AKUTSU, Tokyo (JP); Shogo Iguchi, Tokyo (JP)

(73) Assignee: Honda Motor Co., Ltd., Tokyo (JP)

(21) Appl. No.: 17/669,363

(22) Filed: Feb. 11, 2022

(30) Foreign Application Priority Data
Feb. 26, 2021 (JP) 2021-030101

(51) Int. Cl. G01M 7/02; G01M 7/06

(52) U.S. Cl. CPC G01M 7/022; G01M 7/025; G01M 7/06

(57) ABSTRACT

The disclosure provides an excitation device, in which a vibration in a front-rear direction generated by excitation actuators is input to second bars via excitation arms and excitation shafts, and four wheels are vibrated by the vibrations of the second bars, so as to rotate a vehicle on at least one of a yaw axis, a pitch axis, and a roll axis. A controller controls a phrase and an amplitude of the operation of each of four piston rods of four excitation actuators.

### CROSS-REFERENCE TO RELATED APPLICATION

This application claims the priority benefits of Japanese application no. 2021-030101, filed on Feb. 26, 2021. The entity of the above-mentioned patent application is here by incorporated by reference herein and made a part of the specialization.

### BACKGROUND

### Technical Field

The disclosure relates to an excitation device that excites a vehicle.

### Description of Related Art

In the past, an excitation device described in Patent Literature 1 is known. This excitation device excites the vehicle, and is provided with a placement base on which tires are placed. The placement base is divided into a plurality of compartments that may be displaced in a manner independent of each other, and is provided with a load transmission mechanism that independently transmits a load to each of the plurality of compartments.

### RELATED ART

### Patent Literature

[Patent Literature 1] Japanese Unexamined Patent Publication No. 2005-300312

The excitation device described in Patent Literature 1 improves the accuracy of reproducing the actual road surface running state by dividing the placement base into a plurality of compartments that can be displaced independently of each other, but this has the problem of making the structure more complicated.

The disclosure has been made to solve the above problem, and an object of the disclosure is to provide an excitation device capable of appropriately reproducing an excitation state while a vehicle is running with a simple structure.

### SUMMARY

[1] The excitation device of the disclosure is an excitation device exciting an inspection vehicle having a plurality of wheels. The excitation device includes: a plurality of excitation portions supporting and exciting the plurality of wheels, respectively, and a control unit. The excitation portion includes: provided corresponding to each of the plurality of wheels, a front bar arranged so as to restrict a forward movement of the wheel by abutting the wheel from a front direction of the wheel; a rear bar capable of sandwiching a lower portion of the wheel between itself and the front bar by abutting the wheel from a rear direction of the wheel; and an actuator exciting the wheel by moving the front bar in a front-rear direction. The control unit rotates the inspection vehicle on at least one of a yaw axis, a pitch axis, and a roll axis by controlling an operation of each of the plurality of actuators and controlling a phase and an amplitude of the operation of each of the plurality of actuators.

### BRIEF DESCRIPTION OF THE DRAWINGS

FIG. 1 is a perspective view showing the appearance of an excitation device of an embodiment of the disclosure.

FIG. 2 is a perspective view showing a configuration of a front placement plate portion and an excitation machine.

FIG. 3 is a perspective view showing a configuration of an excitation machine.

FIG. 4 is a plan view showing a configuration of an excitation machine.

FIG. 5 is a view showing a cross section along line CC of FIG. 4.

FIG. 6 is a view showing a state in which a vehicle is placed so as to be excited in an excitation device.

FIG. 7 is a view showing a rotational state of a driving wheel.

FIG. 8 is an explanatory view showing a pressing force acting on a wheel at the time of excitation and a force component thereof.

FIG. 9 is an operation waveform chart of four excitation actuators when pitch axis rotation control is performed.

FIG. 10 is a top view of a vehicle showing yaw axis rotation.

FIG. 11 is an operation waveform chart of four excitation actuators when yaw axis rotation control is performed.

FIG. 12 is a front view of a vehicle showing roll axis rotation.

FIG. 13 is an operation waveform chart of four excitation actuators when roll axis rotation control is performed.

FIG. 14 is a chart showing acceleration detected at a tip portion of a suspension arm.

### DESCRIPTION OF THE EMBODIMENTS

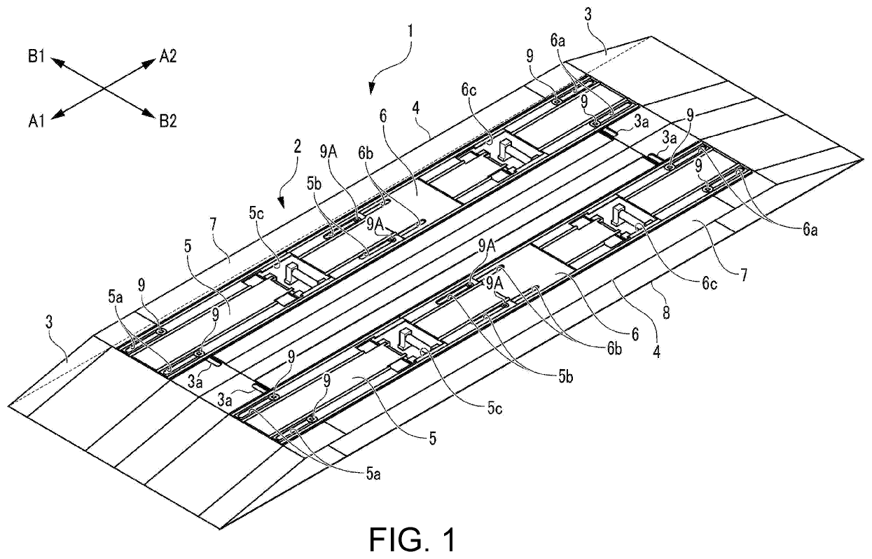

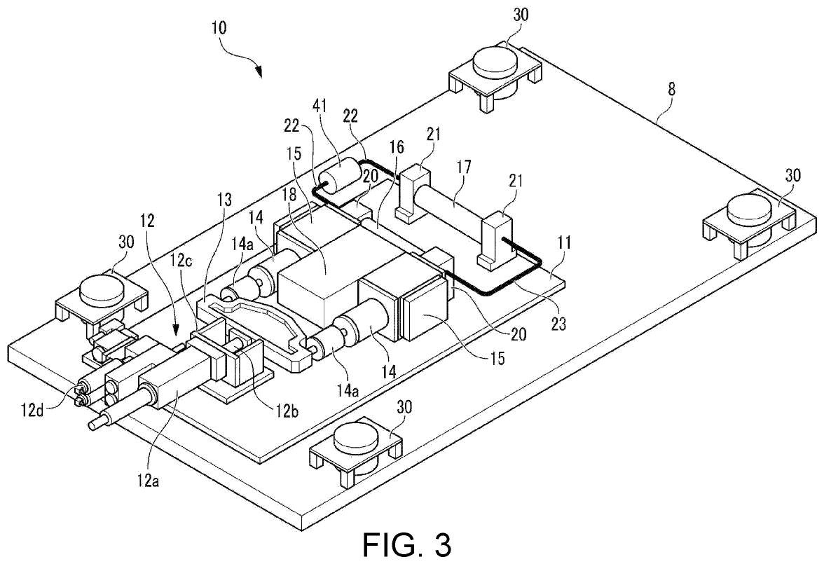

Hereinafter, an excitation device 1 according to an embodiment of the disclosure will be described with reference to the drawings. The excitation device 1 shown in FIG. 1 according to the embodiment excites a vehicle via wheels in order to inspect the vehicle, and the excitation device 1 is provided with four excitation machines 10 (only one is shown in FIG. 3).

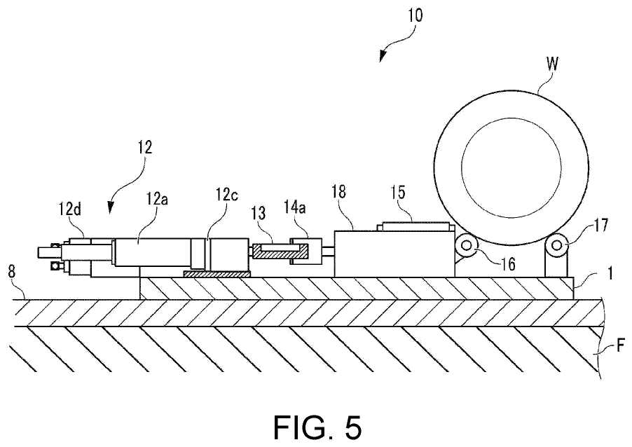

In the excitation device 1, as will be described later, the four wheels (see FIG. 5) in a vehicle V to be inspected are excited by the four excitation machines 10, respectively, thereby the vehicle is inspected to see if there are any abnormal sound, noise, or the like.

The vehicle V of the present embodiment is a front-wheel drive vehicle having an automatic transmission in which left and right front wheels W serve as driving wheels W, and is configured such that creep occurs due to the structure of the automatic transmission (torque converter). In the following description, the rotation of the driving wheels W due to the occurrence of creep is referred to as “creep rotation”.

Further, in the following description, for convenience, A1 side of arrow A1-A2 in FIG. 1 is referred to as “front”; A2 side of arrow A1-A2 is referred to as “rear”; B1 side of arrow B1-B2 is referred to as “right”; B2 side of arrow B1-B2 is referred to as “left”; upper side is referred to as “up”; and lower side is referred to as “down”.

The excitation device 1 is provided with a placement base 2 for placing the vehicle V at the time of inspection, and the placement base 2 is disposed on a floor F (see FIG. 5). The left half and the right half of the placement base 2 are symmetrically configured, so the left half will be described below as an example.

The left half of the placement base 2 includes a placement portion 4 extending in the front-rear direction; and front and rear slope portions 3, 3 provided in the front and rear of the placement portion 4. A surface of the front slope portion 3 has a flat surface portion whose surface is continuous with a front end of the placement portion 4, and an inclined surface whose surface is continuous with the flat surface portion and which extends diagonally forward and downward.

Further, the rear slope portion 3 has a flat surface portion whose surface is continuous with the rear end of the placement portion 4 and an inclined surface whose surface is continuous with the flat surface portion and which extends diagonally rearward and downward. When inspection starts, the vehicle V moves from a floor surface to the placement portion 4 via the rear slope portion 3, and after inspection is completed, moves from the placement portion 4 to the floor surface via the front slope portion 3.

On the other hand, the placement portion 4 includes front and rear placement plate portions 5, 6; a top plate portion 7; a base plate portion 8; and the like in order from the upper side to the lower side. The base plate portion 8 has a flat plate shape extending in the front-rear direction, and its front and rear end portions are integrally fixed to the front and rear slope portions 3, 3. The base plate portion 8 is placed on the floor surface and is firmly fixed to the floor F via fixtures (for example, anchor bolts) (not shown).

The top plate portion 7 extends in the front-rear direction and is arranged in parallel with the base plate portion 8. Further, the front placement plate portion 5 extends in the front-rear direction, a front end portion thereof is placed on the flat surface portion of the front slope portion 3, and a pair of long holes 5a, 5a are formed at left and right end portions thereof. The front end portion of the front placement plate portion 5 is fixed to the front slope portion 3 via hydraulic clamp devices 9 at edge portions of the long holes 5a.

Further, the front slope portion 3 is formed with a long hole 3a extending in the left-right direction, and the hydraulic clamp devices 9 sandwich the front placement plate portion 5 and the front slope portion 3 in the up-down direction in a state of being fitted into the long holes 5a of the front placement plate portion 5 and the long hole 3a of the front slope portion 3. As a result, the front placement plate portion 5 is fixed to the front slope portion 3.

An opening 5c is provided in a central portion of the front placement plate portion 5. The opening 5c is formed in a rectangular shape in a plan view and penetrates the front placement plate portion 5 in the up-down direction. An excitation machine 10 (see FIG. 3) is arranged below the opening 5c, and the details of the excitation machine 10 will be described later.

Further, long holes 5b, 6b are formed in a rear end portion of the front placement plate portion 5 and a front end portion of the rear placement plate portion 6. Hydraulic clamp devices 9A similar to the hydraulic clamp devices 9 sandwich the front placement plate portion 5 and the rear placement plate portion 6 in a state of being fitted into the long holes 5b, 6b. As a result, the front placement plate portion 5 and the rear placement plate portion 6 are fixed to each other by the hydraulic clamp devices 9A.

With the configuration, in a state where the front placement plate portion 5 and the front slope portion 3 are released from being fixed by the hydraulic clamp devices 9, the front placement plate portion 5 is configured to be movable in the left-right direction by the length of the long hole 3a, whereby the front placement plate portion 5 is movable in the left-right direction between a maximum width position shown in FIG. 1 and a minimum width position (not shown).

Further, in the state where the fixing by the hydraulic clamp devices 9, 9A is released, the front placement plate portion 5 is movable in the front-rear direction relative to the front slope portion 3 by the lengths of the long holes 5a, 5b in the front-rear direction. Specifically, the front placement plate portion 5 is configured to be movable in the front-rear direction between a maximum length position shown in FIG. 1 and a minimum length position (not shown).

On the other hand, a rear end portion of the rear placement plate portion 6 is arranged such that an upper surface thereof is at the same height as an upper surface of the front end portion of the front placement plate portion 5, and is configured to be plane-symmetrical with the front end portion of the front placement plate portion 5. That is, the rear end portion of the rear placement plate portion 6 is placed on the flat surface portion of the rear slope portion 3, and a pair of long holes 6a, 6a are formed at left and right end portions thereof.

Further, the long hole 3a extending in the left-right direction is also formed in the rear slope portion 3, and the hydraulic clamp devices 9 sandwich the rear placement plate portion 6 and the rear slope portion 3 in the up-down direction in a state of being fitted into long holes 6a of the rear placement plate portion 6 and the long hole 3a of the rear slope portion 3. As a result, the rear placement plate portion 6 is fixed to the rear slope portion 3.

Further, an opening 6c is provided in a central portion of the rear placement plate portion 6. The opening 6c is formed in a rectangular shape in a plan view, penetrates the rear placement plate portion 6 in the up-down direction, and is configured to have the same size as the opening 5c of the front placement plate portion 5. Further, the excitation machine 10 is arranged below the opening 6c.

With the configuration, in a state where the rear placement plate portion 6 and the rear slope portion 3 are released from being fixed by the hydraulic clamp devices 9, the rear placement plate portion 6 is configured to be movable in the left-right direction by the length of the long hole 3a, whereby the rear placement plate portion 6 is movable in the left-right direction between a maximum width position shown in FIG. 1 and a minimum width position (not shown).

Further, in the state where the fixing by the hydraulic clamp devices 9, 9A is released, the rear placement plate portion 6 is movable in the front-rear direction relative to the rear slope portion 3 by the lengths of the long holes 6a, 6b in the front-rear direction. Specifically, the rear placement plate portion 6 is configured to be movable in the front-rear direction between a maximum length position shown in FIG. 1 and a minimum length position (not shown).

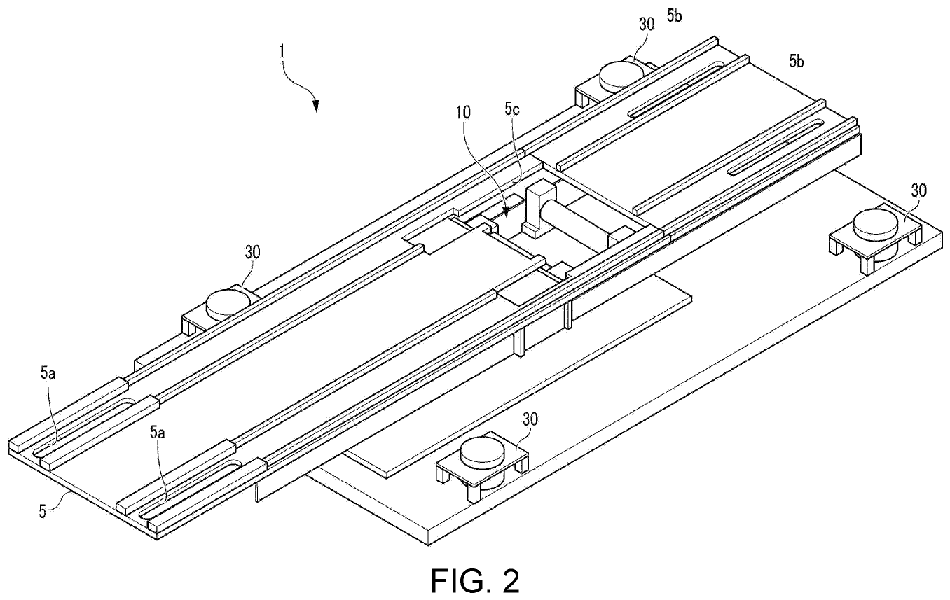

Next, the excitation machine 10 will be described with reference to FIG. 2 to FIG. 8. FIG. 2 shows a configuration in which the top plate portion 7 is omitted for ease of understanding. In the excitation device 1 of the present embodiment, the excitation machine 10 arranged below the opening 5c of the front placement plate portion 5 and the excitation machine 10 arranged below the opening 6c of the rear placement plate portion 6 are configured in the same manner, hereinafter the excitation machine 10 arranged below the opening 5c of the front placement plate portion 5 will be described below as an example.

The excitation machine 10 is provided on a movable base plate 11 having a rectangular shape in a plan view. The movable base plate 11 is fixed to the base plate portion 8 via a magnet clamp (not shown) with a bottom surface thereof in surface contact with an upper surface of the base plate portion 8.

Further, four position changing devices 30 and multiple free bearings (not shown) are provided on the upper surface of the base plate portion 8. The four position changing devices 30 are arranged in a rectangular shape in a plan view, and the movable base plate 11 is provided so as to be surrounded by the position changing devices 30.

Each position changing device 30 includes a plurality of toothed pulleys; a toothed belt wound around the toothed pulleys; and a motor mechanism or the like for driving one toothed pulley (none of which is shown). Two end portions of the toothed belt of each position changing device 30 are connected to four predetermined portions of the movable base plate 11. Further, the multiple free bearings are arranged below the movable base plate 11.

With the configuration, in the state where the fixing by the magnet clamp is released, the movable base plate 11 moves on the base plate portion 8 while rolling the multiple free bearings, as the toothed pulleys rotate in the four position changing devices 30. That is, the movable base plate 11 is configured such that the position relative to the base plate portion 8 may be changed. Then, the movable base plate 11 is fixed to the base plate portion 8 via the magnet clamp at such a changed position.

As shown in FIG. 3 to FIG. 5, the excitation machine 10 includes an excitation actuator 12 (actuator); an excitation arm 13; a pair of excitation shafts 14, 14; a pair of hydrostatic bearings 15, 15; a second bar 16; a first bar 17; a passage base 18, and the like. In FIG. 5, hatching of the cross-sectional portions of the second bar 16 and the first bar 17 is omitted for ease of understanding.

The excitation actuator 12 includes a hydraulic cylinder 12a, a piston rod 12b, a bracket 12c, a hydraulic control circuit mechanism 12d, and the like. The hydraulic cylinder 12a is fixed and supported on the movable base plate 11 and the front placement plate portion 5 via the bracket 12c.

The hydraulic control circuit mechanism 12d is connected to the hydraulic cylinder 12a. By supplying oil pressure from the hydraulic control circuit mechanism 12d, the hydraulic cylinder 12a drives the piston rod 12b in the front-rear direction.

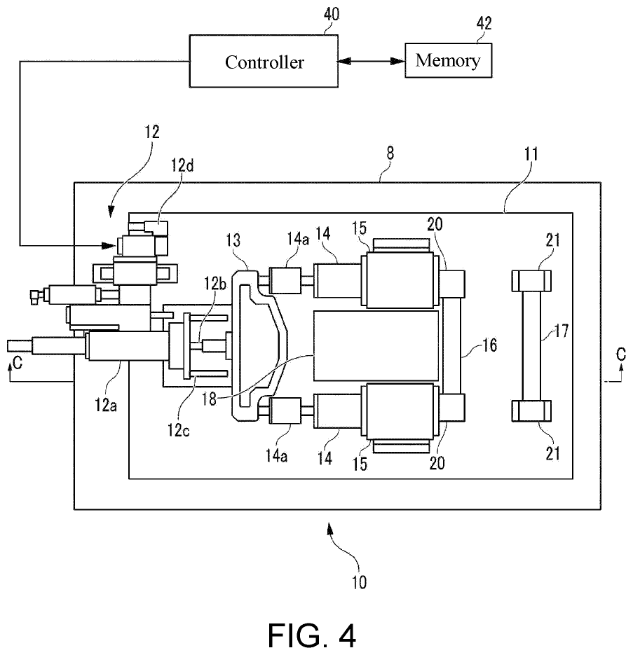

The hydraulic control circuit mechanism 12d is a combination of an electromagnetic spool valve mechanism and a hydraulic circuit, and the like, and is electrically connected to a controller 40 (see FIG. 4) to be described later. In the hydraulic control circuit mechanism 12d, the hydraulic pressure supplied to the hydraulic cylinder 12a is controlled by controlling the electromagnetic spool valve mechanism by the controller 40. As a result, the moving state and the reciprocating state of the piston rod 12b are controlled, such that the operating state of the second bar 16 is controlled.

The controller 40 is configured by a microcomputer including a CPU, a RAM, a ROM, an I/O interface (none of which is shown), and the like, and executes an excitation control process.

By controlling four excitation actuators 12, the controller 40 executes the excitation control process for exciting the vehicle V via four wheels W.

A memory 42 in which a variety of operation control data for operating the excitation actuator 12 are stored is connected to the controller 40, and the controller 40 reads the variety of operation control data stored in the memory 42 and operates the excitation actuator 12.

The memory 42 stores, as operation control data, pitch axis rotating operation control data for rotating the vehicle V on a pitch axis (axis extending in the left-right direction), yaw axis rotating operation control data for rotating the vehicle V on a yaw axis (axis extending in the up-down direction), and roll axis rotating operation control data for rotating the vehicle V on a roll axis (axis extending in the front-rear direction), and the like.

Each operation control data is data for controlling the phase and amplitude of the operation of each of the four excitation actuators 12 (the operation of the four piston rods 12b). For example, as will be described in detail later, it is data in which the operations of the four piston rods 12b are same in phase and same in amplitude.

The excitation arm 13 is connected to tip portion of the piston rod 12b of the excitation actuator 12, thereby the excitation arm 13 is configured to be driven/excited in the front-rear direction via the piston rod 12b.

Left and right end portions of the excitation arm 13 are connected to front end portions of the excitation shafts 14, 14 via ball joints 14a, 14a, respectively. The excitation shafts 14, 14 are arranged at intervals in the left-right direction, and extend parallel to each other in the front-rear direction with a predetermined length. The excitation shafts 14, 14 are rod-shaped members having a circular cross section, and are slidably supported in the front-rear direction by the hydrostatic bearings 15, 15.

Recesses (not shown) are arranged side by side in the front-rear direction at predetermined intervals on an inner peripheral surface of each hydrostatic bearing 15, and the excitation shafts 14, 14 are slidably supported by the hydraulic pressure generated by the recesses. An upper surface of the hydrostatic bearing 15 is fixed to the front placement plate portion 5, and a lower surface is fixed to the movable base plate 11.

Further, the excitation shafts 14, 14 have two axes installation portions 20, 20 at rear end portions, respectively, and the second bar 16 is provided between the axis installation portions 20, 20. Further, a pair of axis installation portions 21, 21 are provided behind the second bar 16, and the first bar 17 is provided between the axis installation portions 21, 21. In the present embodiment, the first bar 17 corresponds to a rear bar, and the second bar 16 corresponds to a front bar.

Further, during the operation of the excitation machine 10, the second bar 16 is driven by the excitation actuator 12 at least between an excitation position (for example, the position shown in FIG. 5) and an extrusion position (not shown). Further, the vibration in the front-rear direction generated by the excitation actuator 12 is input to the second bar 16 via the excitation arm 13 and the excitation shafts 14, 14.

Further, the passage base 18 is arranged between the hydrostatic bearings 15, 15 on the movable base plate 11, and has a built-in hydraulic actuator (not shown). The passage base 18 is driven by the hydraulic actuator at least in the front-rear direction between a retreat position (for example, the position shown in FIG. 5) and an abutting position (not shown) that abuts the second bar 16 in the extrusion position.

When the passage base 18 moves to the abutting position and abuts the second bar 16 at the extrusion position, the second bar 16 is held non-rotatably by the passage base 18. This is because, after the excitation operation is completed, when the wheel W of the vehicle V moves forward while climbing over the second bar 16, by holding the second bar 16 in a rotation-stopped state, the driving force of the wheel W is transmitted to the second bar 16 such that the wheel W can easily move forward.

The left half of the placement base 2 is configured as described, and the right half of the placement base 2 is similarly configured.

Next, the operation when inspecting the vehicle V with the excitation device 1 configured as described will be described. First, the hydraulic clamp devices 9, 9A and the magnet clamp are loosened, and the two front placement plate portions 5, the two rear placement plate portions 6, and four movable base plates 11 are set in a movable state.

Next, the four movable base plates 11 are respectively moved to positions corresponding to the wheelbases and treads of the vehicle V to be inspected by the four position changing devices 30, and then fixed to the base plate portion 8 by the magnet clamp. As the movable base plates 11 move, the two front placement plate portions 5 and the two rear placement plate portions 6 move to the positions corresponding to the wheelbases and the treads at the same time as the movable base plates 11. Then, at these positions, the front placement plate portions 5 and rear placement plate portions 6 are fixed to each other via the hydraulic clamp devices 9A, and at the same time fixed to the front and rear slope portions 3, 3 via the hydraulic clamp devices 9, 9.

Next, the excitation actuator 12 in each excitation machine 10 is driven, and a distance between the first bar 17 and the second bar 16 is set to a value that matches the size of the wheel W of the vehicle V to be inspected. This completes the preparation for inspection.

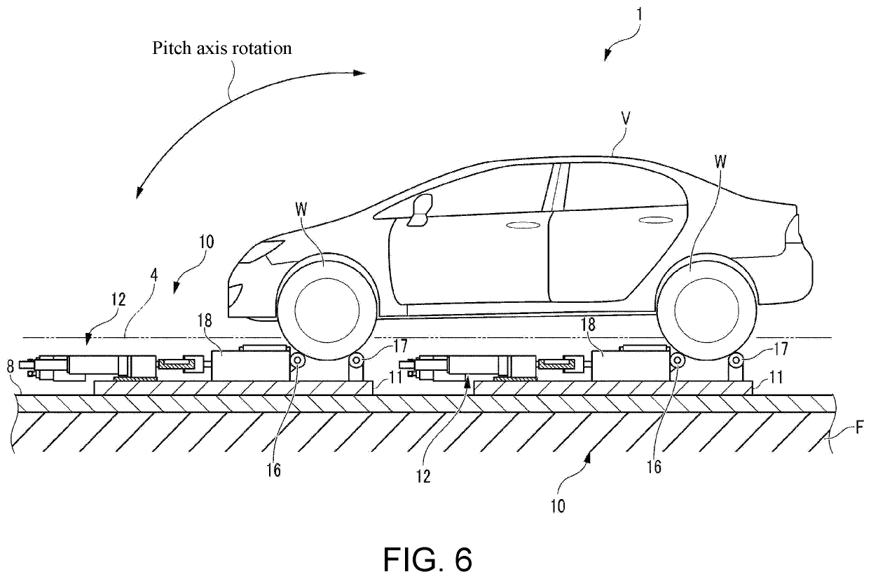

Next, the vehicle V is moved so as to ride on the placement base 2 from the rear slope portion 3, and as shown in FIG. 6, the four wheels W fit into the openings 5c of the front placement plate portion 5 and the openings 6c of the rear placement plate portion 6 and move downward to be sandwiched by the first bar 17 and the second bar 16 from the front-rear direction.

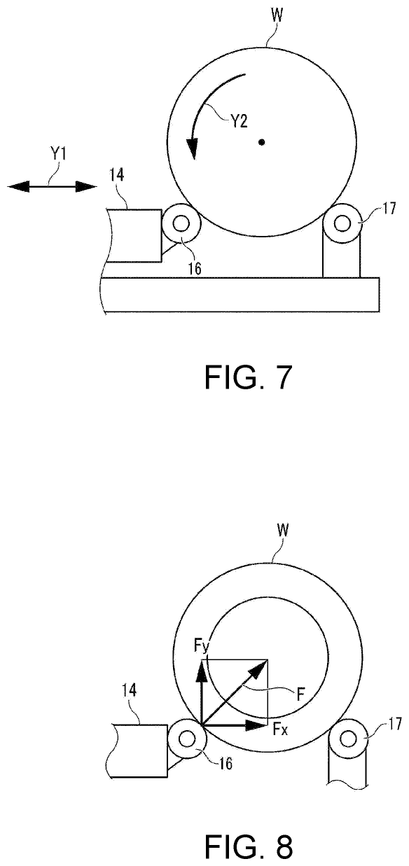

In this state, the excitation control process is executed by the controller 40, as shown by arrow Y1 in FIG. 7, such that the second bar 16 is excited by the excitation actuator 12 in the front-rear direction, and the wheel W is excited accordingly. During this excitation, when a pressing force Fo of the second bar 16 acts on the wheel W, as shown in FIG. 8, two force components Fx, Fy of the pressing force Fo act on the wheel W. That is, by exciting the second bar 16 in the front-rear direction, the wheel W is simultaneously excited in the front-rear direction and the up-down direction.

[Pitch Axis Rotation Control]

Next, the control when the vehicle V is rotated with the pitch axis (an axis extending in the left-right direction) will be described. In the present embodiment, the pitch axis is, for example, an axis extending in the left-right direction from the position of the center of gravity of the vehicle.

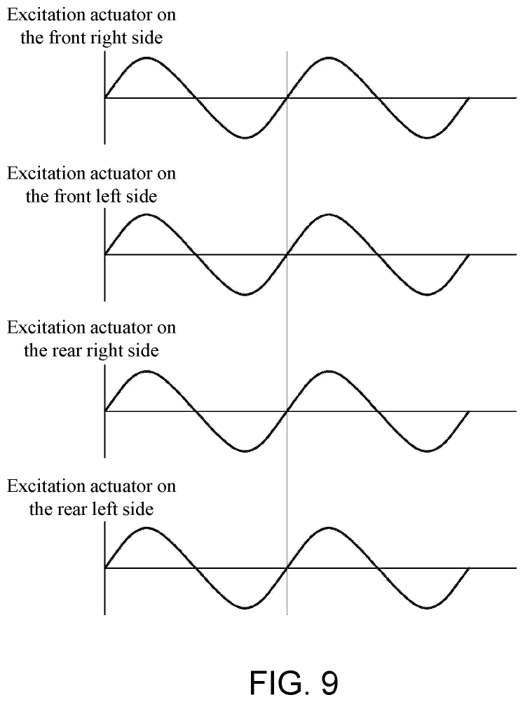

From the memory 42, the controller 40 reads the pitch axis rotating operation control data for rotating the vehicle V on the pitch axis. The pitch axis rotating operation control data is data for operating plurality of excitation actuators 12 so as to move the piston rods 12b of the four excitation actuators 12 in the front-rear direction with the phase and amplitude as shown in FIG. 9.

Specifically, hydraulic pressure is supplied from the hydraulic control circuit mechanism 12d by an operation command (signal) from the controller 40, and by this hydraulic supply, the hydraulic cylinder 12a moves the piston rod 12b in the front-rear direction. The controller 40 controls the phase and amplitude of the piston rod 12b by controlling the amount of hydraulic pressure supplied from the hydraulic control circuit mechanism 12d.

In the present embodiment, as shown in FIG. 9, the controller 40 controls the four piston rods 12b to be moved in the front-rear direction in same phase and amplitude. That is, the controller 40 controls the phase and amplitude of the operation of each of the four excitation actuators 12 (the operations of the four piston rods 12b).

Further, with the pitch axis rotation control, the vibration is controlled at a frequency close to the resonance frequency (for example, about 2 Hz) of the pitch axis rotation of the vehicle V.

By such control, the vibration in the front-rear direction generated by the excitation actuators 12 are input to the second bars 16 via the excitation arms 13 and the excitation shafts 14, 14; the vibrations same in phase and same in amplitude are applied to the four wheels W by the vibrations of the second bars 16, thereby the vehicle V is rotated on the pitch axis (see FIG. 6).

The amplitude of the excitation waveform obtained by adding the operation waveforms of the four piston rods 12b increases when the operations are same in phase. With the control, since the four piston rods 12b are controlled to be moved in the front-rear direction in same phase and amplitude, the vehicle V can be easily rotated on the pitch axis while reducing the amount of operation of each of the four piston rods 12b.

[Yaw Axis Rotation Control]

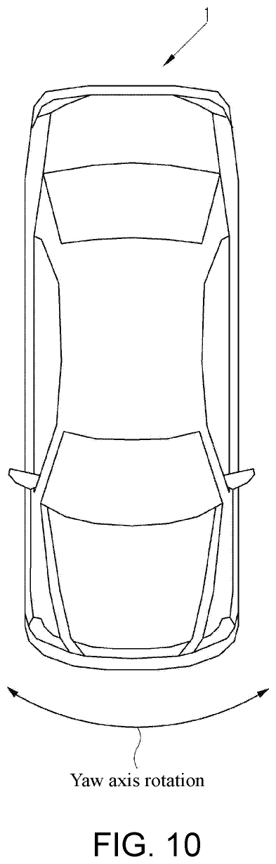

Next, as shown in FIG. 10, the control when the vehicle V is rotated with the yaw axis (an axis extending in the up-down direction) will be described. In the present embodiment, the pitch axis is, for example, an axis extending in the up-down direction from the position of the center of gravity of the vehicle.

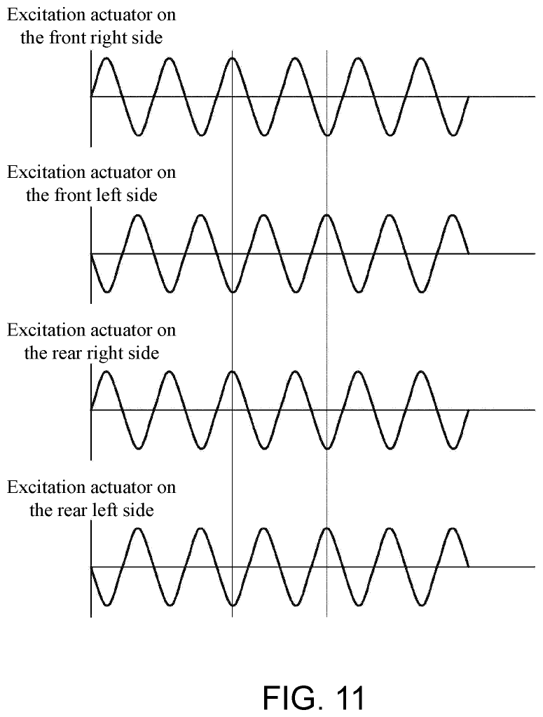

From the memory 42, the controller 40 reads the yaw axis rotating operation control data for rotating the vehicle V on the yaw axis. The yaw axis rotating operation control data is data for operating the plurality of excitation actuators 12 so as to move the piston rods 12b of the four excitation actuators 12 in the front-rear direction with the phase and amplitude as shown in FIG. 11.

In the present embodiment, the piston rod 12b of the excitation actuator 12 on the front right side and the piston rod 12b of the excitation actuator 12 on the front left side are controlled to be moved in the front-rear direction in opposite phase and same amplitude.

Further, with the yaw axis rotation control, the vibration is controlled at a frequency close to the resonance frequency (for example, about 15 Hz) of the yaw axis rotation of the vehicle V. Therefore, with the yaw axis rotation control, the operating frequency of the piston rod 12b of each of the four excitation actuators 12 shown in FIG. 11 has a shorter cycle than the operation of each of the four piston rods 12b shown in FIG. 9 during the pitch axis rotation control.

Further, the controller 40 controls the piston rod 12b of the excitation actuator 12 on the rear right side to be moved in the front-rear direction in same phase and amplitude as the piston rod 12b of the excitation actuator 12 on the front right side, and controls the piston rod 12b of the rear excitation actuator 12 on the rear left side to be moved in the front-rear direction in same phase and amplitude as the piston rod 12b of the excitation actuator 12 on the front left side.

In this way, the controller 40 controls that the piston rod 12b of the excitation actuator 12 on the rear right side and the piston rod 12b of the excitation actuator 12 on the rear left side are moved in the front-rear direction in opposite phase and same amplitude. That is, the controller 40 controls the phase and amplitude of the operation of each of the four excitation actuators 12 (the operation of the four piston rods 12b).

By such control, the vibration in the front-rear direction generated by the excitation actuators 12 are input to the second bars 16 via the excitation arms 13 and the excitation shafts 14, 14; the vibrations same in phase and same in amplitude are applied to the front right wheel W and the rear right wheel W by the vibrations of the second bars 16; the vibrations opposite in phase and same in amplitude as those of the front right wheel W and the rear right wheel W are applied to the front left wheel W and the rear left wheel W; the vibrations same in phase and same in amplitude are applied to the four wheels W; and the vehicle V is rotated on the yaw axis (see FIG. 10).

The amplitude of the excitation waveform obtained by adding the operation waveforms of the four piston rods 12b increases when the operations are opposite in phase on the left and right. With the control, the four piston rods 12b are controlled to be moved in the front-rear direction in opposite phase and same amplitude on the left and right, therefore the vehicle V can be easily rotated on the yaw axis while reducing the amount of operation of each of the four piston rods 12b.

[Roll Axis Rotation Control]

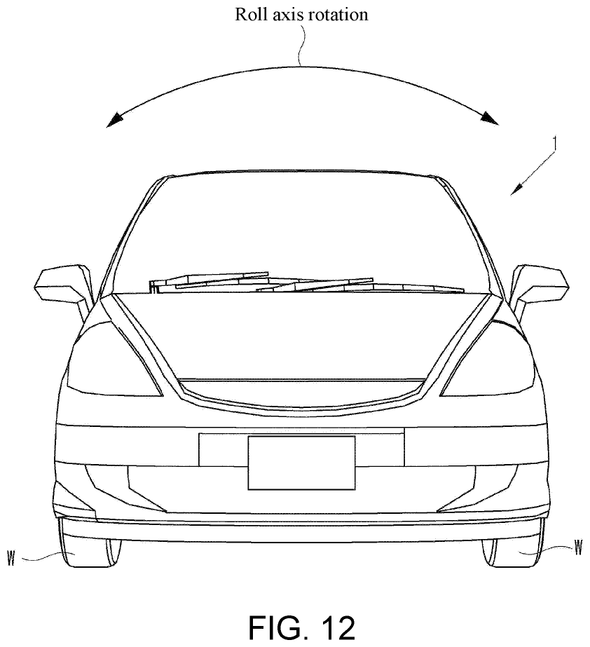

Next, as shown in FIG. 12, the control when the vehicle V is rotated with the roll axis (an axis extending in the front-rear direction) will be described. In the present embodiment, the roll axis is, for example, an axis extending in the front-rear direction from the position of the center of gravity of the vehicle.

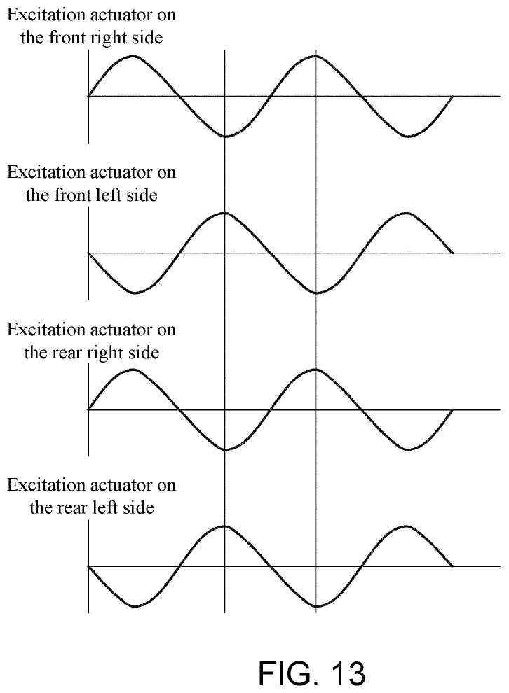

From the memory 42, the controller 40 reads the roll axis rotating operation control data for rotating the vehicle V on the roll axis. The roll axis rotating operation control data is data for operating the plurality of excitation actuators 12 so as to move the piston rods 12b of the four excitation actuators 12 in the front-rear direction with the phase and amplitude as shown in FIG. 13.

In the present embodiment, the piston rod 12b of the excitation actuator 12 on the front right side and the piston rod 12b of the excitation actuator 12 on the front left side are controlled to be moved in the front-rear direction in opposite phase and same amplitude. Further, the vibration is controlled at a frequency close to the resonance frequency (for example, about 0.5 Hz) of the roll axis rotation of the vehicle V.

Further, the piston rod 12b of the excitation actuator 12 on the rear right side is controlled to be moved in the front-rear direction in same phase and amplitude as the piston rod 12b of the excitation actuator 12 of the front right side, and the piston rod 12b of the excitation actuator 12 on the rear left side is controlled to be moved in the front-rear direction in same phase and amplitude as the piston rod 12b of the excitation actuator 12 on the front left side.

In this way, the controller 40 controls that the piston rod 12b of the excitation actuator 12 on the rear right side and the piston rod 12b of the excitation actuator 12 on the rear left side are moved in the front-rear direction in opposite phase and same amplitude. That is, the controller 40 controls the phase and amplitude of the operation of each of the four excitation actuators 12 (the operation of the four piston rods 12b).

By such control, the vibration in the front-rear direction generated by the excitation actuators 12 are input to the second bars 16 via the excitation arms 13 and the excitation shafts 14, 14; the vibrations same in phase and same in amplitude are applied to the front right wheel W and the rear right wheel W by the vibrations of the second bars 16; the vibrations opposite in phase and same in amplitude as those of the front right wheel W and the rear right wheel W are applied to the front left wheel W and the rear left wheel W; the vibrations same in phase and same in amplitude are applied to the four wheels W; and the vehicle V is rotated on the roll axis (see FIG. 12).

The amplitude of the excitation waveform obtained by adding the operation waveforms of the four piston rods 12b increases when the operations are opposite in phase on the left and right. With the control, the four piston rods 12b are controlled to be moved in the front-rear direction in opposite phase and same amplitude on the left and right, therefore the vehicle V can be easily rotated by the roll axis while reducing the amount of operation of each of the four piston rods 12b.

Further, the controller 40 performs the pitch axis rotation control, the yaw axis rotation control, and the roll axis rotation control a plurality of times with different phases and amplitudes. At this time, the abnormal sound in the vehicle V is checked. If abnormal sound is generated in the vehicle V, the control details (phase and amplitude) and the location where the abnormal sound is generated (for example, the central part of the dashboard) are recorded.

Then, when performing a vibration inspection of another vehicle V of the same vehicle type, the vibration inspection is performed based on the control details (phase and amplitude) when an abnormal sound is generated on the dashboard. As a result, it is easy to check in advance whether or not an abnormal sound has occurred at a location where the abnormal sound is to be checked.

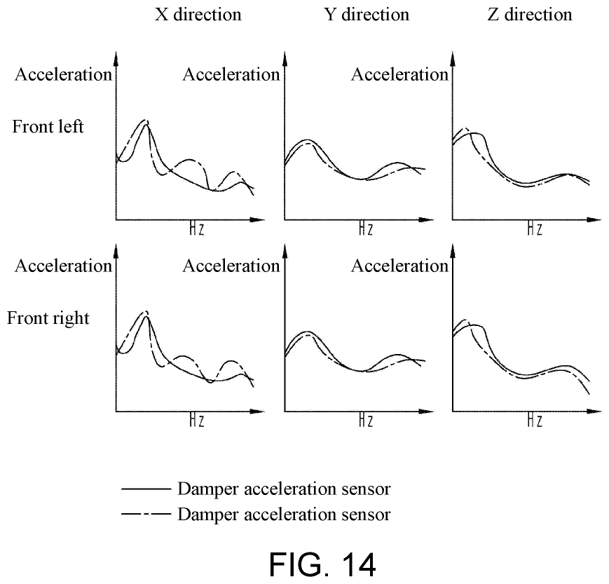

When performing the inspection, a damper acceleration sensor may be provided at a tip (upper end) portion of a suspension (the tip (upper end) portion of the damper) that has suspension arms, a spring, and a damper and supports each of the left and front right axles of the vehicle V, and an arm acceleration sensor may further be provided at rear portions of each of the left and right suspension arms. Each acceleration sensor may detect the acceleration (X direction, Y direction, Z direction) at the time of inspection. FIG. 14 shows the acceleration detection result.

As a result, by simultaneously monitoring the movement under the spring of the suspension (the operation of the four piston rods 12b) and the movement on the spring (the detected acceleration detected by the acceleration sensor), it is possible to monitor the operation of a variety of road surface vibrations at the time of input in three dimensions. Accordingly, it can be used for the design based on the degree of impact of vibration transmission paths, damper characteristics, and damping characteristics of bushes.

In the above embodiment, when the pitch axis rotation control, the yaw axis rotation control, and the roll axis rotation control are performed, the four piston rods 12b are operated with same amplitude, but they do not have to be the same in amplitude; the amplitude difference of operation may be within a predetermined range, and the predetermined range is preferably close to 0.

Further, in the above embodiment, when the yaw axis rotation control and the roll axis rotation control are performed, the left and right piston rods 12b are operated in opposite phase, but they do not have to be in opposite phase; the left and right piston rods 12b may be operated to generate a phase difference in the operation of the left and right piston rods 12bs. For example, when the phases of the operations of the left and right piston rods 12b are shifted by, for example, 90°, the pitch axis rotation and the roll axis rotation occur at the same time.

In the above embodiment, although the four piston rods 12b are operated in same phase or opposite phase, they do not have to be in same phase; a phase difference may be generated so as to be substantially same in phase or substantially opposite in phase.

In the above embodiment, the vehicle V is a four-wheel vehicle type is used, but a two-wheel to three-wheel vehicle or a vehicle having six or more wheels may be used instead.

According to the excitation device of the disclosure, since the control unit controls the operation of each of the plurality of actuators and controls the phase and amplitude of the operation of each of the plurality of actuators so as to rotate the inspection vehicle on at least one of a yaw axis, a pitch axis, and a roll axis, by unidirectional excitation from the front to the rear of the front bar, it is possible to appropriately reproduce the excitation state while the vehicle is running.

[2] It is preferable that the control unit operates each of the plurality of actuators such that the operation of each of the plurality of actuators is substantially same in phase, so as to rotate the inspection vehicle on the pitch axis.

The amplitude of the excitation waveform obtained by adding the operation waveforms of each of the plurality of actuators increases when the operations are same in phase. According to the configuration, each of the plurality of actuators is operated such that the operation of each of the plurality of actuators is substantially same in phase, therefore the inspection vehicle can be easily rotated on the pitch axis while reducing the amount of operation of each of the plurality of actuators.

[3] It is preferable that the control unit operates each of the plurality of actuators such that an amplitude difference in the operation of each of the plurality of actuators is within a predetermined range, so as to rotate the inspection vehicle on the pitch axis.

The amplitude of the excitation waveform obtained by adding the operation waveforms of each of the plurality of actuators increases when the operations are same in amplitude. According to the configuration, each of the plurality of actuators is operated such that the amplitude difference of the operation of each of the plurality of actuators is within a predetermined range, therefore the inspection vehicle can be easily rotated on the pitch axis while reducing the amount of operation of each of the plurality of actuators.

[4] It is preferable that the plurality of wheels are arranged side by side in a left-right direction, and the control unit operates each of the plurality of actuators to generate a phase difference in the operation of each of the plurality of actuators corresponding to the wheels arranged in the left-right direction, so as to rotate the inspection vehicle at least on the yaw axis.

The amplitude of the excitation waveform obtained by adding the operation waveforms of each of the plurality of actuators increases when a phase difference is generated in each operation. According to the configuration, each of the plurality of actuators is operated to generate a phase difference in the operation of each of the plurality of actuators, therefore the inspection vehicle can be easily rotated on the yaw axis while reducing the amount of operation of each of the plurality of actuators.

[5] It is preferable that the control unit operates each of the plurality of actuators such that the operation of each of the plurality of actuators corresponding to the wheels arranged in the left-right direction is substantially opposite in phase.

The amplitude of the excitation waveform obtained by adding the operation waveforms of each of the plurality of actuators is largest when the operations are opposite in phase. According to the configuration, each of the plurality of actuators is operated such that the operation of each of the plurality of actuators is substantially opposite in phase, therefore the inspection vehicle can be easily rotated on the yaw axis while reducing the amount of operation of each of the plurality of actuators.

[6] It is preferable that the control unit operates each of the plurality of actuators such that an amplitude difference in the operation of each of the plurality of actuators is within a predetermined range.

The amplitude of the excitation waveform obtained by adding the operation waveforms of each of the plurality of actuators increases when the operations are same in amplitude. According to the configuration, by setting a predetermined range with a value close to 0 and operating each of the plurality of actuators such that the amplitude difference of the operation of each of the plurality of actuators is within the predetermined range, the inspection vehicle can be easily rotated on the yaw axis while reducing the amount of operation of each of the plurality of actuators.

[7] It is preferable that the plurality of wheels are arranged side by side in the left-right direction, and the control unit operates each of the plurality of actuators to generate a phase difference in the operation of each of the plurality of actuators corresponding to the wheels arranged in the left-right direction, so as to rotate the inspection vehicle at least on a roll axis.

The amplitude of the excitation waveform obtained by adding the operation waveforms of each of the plurality of actuators increases when a phase difference is generated in each operation. According to the configuration, each of the plurality of actuators is operated to generate a phase difference in the operation of each of the plurality of actuators, therefore the inspection vehicle can be easily rotated by the roll axis while reducing the amount of operation of each of the plurality of actuators.

[8] It is preferable that the control unit operates each of the plurality of actuators such that the operation of each of the plurality of actuators corresponding to the wheels arranged in the left-right direction is substantially opposite in phase.

The amplitude of the excitation waveform obtained by adding the operation waveforms of each of the plurality of actuators is largest when the operations are opposite in phase. According to the configuration, each of the plurality of actuators is operated such that the operation of each of the plurality of actuators is substantially opposite in phase, therefore the inspection vehicle can be easily rotated by the roll axis while reducing the amount of operation of each of the plurality of actuators.

[9] It is preferable that the control unit operates each of the plurality of actuators such that an amplitude difference in each operation of the plurality of actuators is within a predetermined range.

The amplitude of the excitation waveform obtained by adding the operation waveforms of each of the plurality of actuators increases when the operations are same in amplitude. According to the configuration, by setting a predetermined range with a value close to 0 and operating each of the plurality of actuators such that the amplitude difference of the operation of each of the plurality of actuators is within the predetermined range, the inspection vehicle can be easily rotated by the roll axis while reducing the amount of operation of each of the plurality of actuators.

What is claimed is:

1. An excitation device exciting an inspection vehicle having a plurality of wheels, the excitation device comprising:
a plurality of excitation portions supporting and exciting the plurality of wheels, respectively, the excitation portion comprising: provided corresponding to each of the plurality of wheels, a front bar arranged so as to restrict a forward movement of the wheel by abutting the wheel from a front direction of the wheel; a rear bar capable of sandwiching a lower portion of the wheel between itself and the front bar by abutting the wheel from a rear direction of the wheel; and an actuator exciting the wheel by moving the front bar in a front-rear direction, and
a control unit rotating the inspection vehicle on at least one of a yaw axis, a pitch axis, and a roll axis by controlling an operation of each of the plurality of actuators and controlling a phase and an amplitude of the operation of each of the plurality of actuators.

2. The excitation device according to claim 1,
wherein the control unit operates each of the plurality of actuators such that the operation of each of the plurality of actuators is substantially same in phase, so as to rotate the inspection vehicle on the pitch axis.

3. The excitation device according to claim 2,
wherein the control unit operates each of the plurality of actuators such that an amplitude difference in the operation of each of the plurality of actuators is within a predetermined range, so as to rotate the inspection vehicle on the pitch axis.

4. The excitation device according to claim 1,
wherein the plurality of wheels are arranged side by side in a left-right direction, and
the control unit operates each of the plurality of actuators to generate a phase difference in the operation of each of the plurality of actuators corresponding to the wheels arranged in the left-right direction, so as to rotate the inspection vehicle at least on the yaw axis.

5. The excitation device according to claim 4,
wherein the control unit operates each of the plurality of actuators such that the operation of each of the plurality of actuators corresponding to the wheels arranged in the left-right direction is substantially opposite in phase.

6. The excitation device according to claim 4,
wherein the control unit operates each of the plurality of actuators such that an amplitude difference in the operation of each of the plurality of actuators is within a predetermined range.

7. The excitation device according to claim 1,
wherein the plurality of wheels are arranged side by side in the left-right direction, and
the control unit operates each of the plurality of actuators to generate a phase difference in the operation of each of the plurality of actuators corresponding to the wheels arranged in the left-right direction, so as to rotate the inspection vehicle at least on the roll axis.

8. The excitation device according to claim 7,
wherein the control unit operates each of the plurality of actuators such that the operation of each of the plurality of actuators corresponding to the wheels arranged in the left-right direction is substantially opposite in phase.

9. The excitation device according to claim 7,
wherein the control unit operates each of the plurality of actuators such that an amplitude difference in each operation of the plurality of actuators is within a predetermined range.
